(19) United States
(12) Patent Application Publication
(10) Pub. No.: US 2025/0226897 A1
(43) Pub. Date: Jul. 10, 2025

(54) COMMUNICATION APPARATUS, COMMUNICATION METHOD, AND STORAGE MEDIUM

(71) Applicant: CANON KABUSHIKI KAISHA, Tokyo (JP)

(72) Inventor: EIGORO INA, Kanagawa (JP)

(21) Appl. No.: 19/007,837

(22) Filed: Jan. 2, 2025

(30) Foreign Application Priority Data
Jan. 9, 2024 (JP) 2024-001498

(51) Int. Cl. H04B 17/318; H04W 16/14; H04W 84/12

(52) U.S. Cl. CPC H04B 17/318; H04W 16/14; H04W 84/12

(57) ABSTRACT

A communication apparatus obtains information on first transmission signal strength of a first radio frame included in the first radio frame transmitted from a first other communication apparatus of an OBSS, and obtains reception signal strength when the first radio frame is detected, specifies propagation loss with the first other communication apparatus from the first transmission signal strength and the reception signal strength, determines a second transmission signal strength to be used in transmission of a third radio frame using spatial reuse (SR) based on the propagation loss specified when a second radio frame transmitted from a second other communication apparatus of the OBSS with the first other communication apparatus as a destination permits SR, and transmits the third radio frame using SR while the second radio frame is being transmitted using the second transmission signal strength.

### BACKGROUND OF THE INVENTION

### Field of the Disclosure

The present disclosure relates to a technique for improving efficiency of wireless communication.

### Description of the Related Art

As a communication standard related to a wireless local area network (LAN), Institute of Electrical and Electronics Engineers (IEEE) 802.11 series standard is known. In the IEEE 802.11 series standards, a technique for improving communication efficiency in an overlapping basic service set (OBSS) environment in which communication ranges of a plurality of networks (basic service set (BSS)) overlap with one another has been studied. Japanese Patent Laid-Open No. 2017-225091 describes a technique of increasing communication opportunities in an OBSS environment using BSS color for identifying a BSS.

### SUMMARY

There is a spatial reuse (SR) technology that permits communication using the same frequency channel as that of an OBSS in response to satisfaction of a specific condition while communication is being performed in the OBSS. The present disclosure provides a technology for improving use efficiency of wireless media by efficiently using the SR technology.

According to one aspect of the present disclosure, there is provided a communication apparatus that performs wireless communication compliant with IEEE 802.11 standard, comprising: at least one memory storing instructions; and at least one processor that executes the instructions stored in the at least one memory to cause the communication apparatus to perform: obtaining information on first transmission signal strength of a first radio frame, the information being included in the first radio frame transmitted from a first other communication apparatus of an overlapping basic service set (OBSS), and obtaining reception signal strength when the first radio frame is detected; specifying propagation loss between the first other communication apparatus and the communication apparatus from the first transmission signal strength and the reception signal strength; determining a second transmission signal strength to be used in transmission of a third radio frame using spatial reuse (SR) based on the propagation loss specified when a second radio frame transmitted from a second other communication apparatus of the OBSS with the first other communication apparatus as a destination permits SR; and transmitting the third radio frame using SR while the second radio frame is being transmitted using the second transmission signal strength.

According to another aspect of the present disclosure, there is provided a communication apparatus that performs wireless communication compliant with IEEE 802.11 standard, comprising: at least one memory storing instructions; and at least one processor that executes the instructions stored in the at least one memory to cause the communication apparatus to perform: transmitting a radio frame in which information on transmission signal strength of the radio frame is included in the radio frame when use of spatial reuse (SR) is permitted in the radio frame to be transmitted, or a reception acknowledgement frame in which information on transmission signal strength of the reception acknowledgement frame is included in the reception acknowledgement frame when a radio frame in which use of SR is permitted is received.

Further features of the present disclosure will become apparent from the following description of exemplary embodiments with reference to the attached drawings.

### BRIEF DESCRIPTION OF THE DRAWINGS

FIG. 1 is a view illustrating a configuration example of a wireless communication system.

FIG. 2 is a view illustrating a hardware configuration example of a communication apparatus.

FIG. 3 is a block diagram illustrating a functional configuration example of the communication apparatus.

FIG. 4 is a view describing a flow of communication.

FIG. 5 is a view showing an example of a flow of processing executed by an AP 101.

### DESCRIPTION OF THE EMBODIMENTS

Hereinafter, embodiments will be described in detail by referring to the accompanying drawings. Note that the following embodiments do not limit the disclosure according to the claims. Although a plurality of features are described in the embodiments, not all of the plurality of features are essential to the disclosure, and the plurality of features may be arbitrarily combined. Further, in the accompanying drawings, identical or similar components are denoted by identical reference signs, and redundant description will be omitted.

### System Configuration

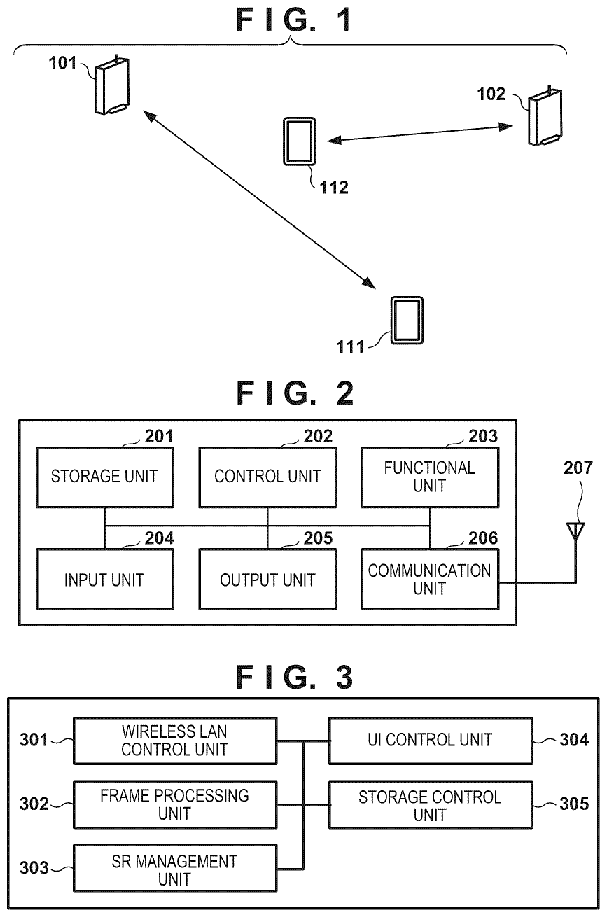

FIG. 1 illustrates a configuration example of a wireless communication system according to the present embodiment. This wireless communication system is configured using a wireless LAN compliant with the IEEE 802.11 series standards, for example. Note that IEEE is an abbreviation for Institute of Electrical and Electronics Engineers, and LAN is an abbreviation for Local Area Network. Although FIG. 1 illustrates, as an example, two access points (AP) and two stations (STA) each compliant with the IEEE 802.11 series standards, the wireless communication system may naturally include more than four communication apparatuses.

Note that the wireless communication system of FIG. 1 assumes that an STA 111 participates in a network (basic service set (BSS), not illustrated) constructed by the AP 101, and communication is performed between the AP 101 and the STA 111. It is assumed that an STA 112 participates in a BSS (not illustrated) constructed by an AP 102, and communication is performed between the AP 102 and the STA 112. Note that these communication apparatuses can communicate at frequencies of the 2.4 GHz band, the 5 GHz band, and the 6 GHz band. Note that the frequency bands used by the communication apparatuses are not limited to them, and other frequency bands such as the 60 GHz band, for example, may be used. Each of the communication apparatuses can communicate by using bandwidths of 20 MHz, 40 MHz, 80 MHz, 160 MHz, and 320 MHz. However, these are merely examples, and bandwidths such as 240 MHz and 4 MHz, for example, may be used.

Each of the communication apparatuses is configured to be able to execute communication compliant with the IEEE 802.11ax (HE) standard in which spatial reuse (SR) described later is adopted among the IEEE 802.11 series standards, for example. Note that in addition to the IEEE 802.11ax standard, each of the communication apparatuses may support legacy standards (e.g., at least any of the IEEE 802.11a/b/g/n/ac standards) standardized before the IEEE 802.11ax standard. Each of the communication apparatuses may support standards standardized after the IEEE 802.11ax, such as the IEEE 802.11be standard or the IEEE 802.11bn standard. In addition to the IEEE 802.11 series standards, each of the communication apparatuses may support other communication standards such as Bluetooth (registered trademark), NFC, UWB, ZigBee, and MBOA. Note that UWB is an abbreviation for ultra wide band, and MBOA is an abbreviation for Multiband OFDM Alliance. Here, OFDM is an abbreviation for orthogonal frequency division multiplexing. NFC is an abbreviation for near field communication. UWB includes wireless USB, wireless 1394, and WiNET. Each of the communication apparatuses may support communication standards of wired communication such as a wired LAN.

The AP 101 and the AP 102 can be, for example, wireless LAN routers or personal computers (PC), but are not limited to them. The STA 111 and the STA 112 can be, for example, cameras, tablets, smartphones, PCs, mobile phones, video cameras, wearable devices such as headsets or smart glasses, or printers, but are not limited to them. The AP 101 and the AP 102 and the STA 111 and the STA 112 may be information processing apparatuses such as radio chips supporting standards such as the IEEE 802.11ax.

In the present embodiment, as described above, each of the communication apparatuses (AP 101 and AP 102 and STA 111 and STA 112) can perform communication compliant with standards that can use the spatial reuse (SR). The SR is a communication technology for efficiently using wireless media in an overlapping BSS (OBSS) environment in which a plurality of BSSs are geographically overlapped and arranged. In the SR, in a period in which communication is performed by using a predetermined frequency channel in any BSS, communication in which the frequency channel is spatially reused is performed in the OBSS for the BSS. That is, in the SR, it is permitted that communication at a position where communication in any BSS is not affected is performed concurrently. This enables communication to be performed using a common frequency channel among the plurality of BSSs, and enables effective utilization of wireless media.

Currently, two types of SR processing methods (parameterized spatial reuse (PSR)-based SR and OBSS power detect (PD) based SR) are defined in the IEEE 802.11 standards. In the PSR-based SR, a communication apparatus of the BSS reads parameters from a trigger frame transmitted in the OBSS. From the trigger frame, as parameters, target transmission signal strength of the trigger frame transmitted by an AP, strength of a signal received from the AP, signal strength of interference waves to be permitted, and the period of a series of radio frames executed subsequently from the trigger frame are obtained. Then, in the PSR-based SR, the radio frame of the BSS is transmitted with the transmission signal strength determined using the parameter on the same frequency channel as the radio frame transmitted in the OBSS in response to the trigger frame. In the PSR-based SR, since the above-described parameter needs to be read from the trigger frame, the SR cannot be used in a case of performing communication not using the trigger frame in the OBSS. In other words, in the OBSS, unless a trigger based (TB) physical layer protocol data unit (PPDU) is transmitted, the PSR- based SR cannot be applied in the BSS.

In the OBSS PD based SR, regardless of the type of the radio frame transmitted by the OBSS, the transmission signal strength is determined corresponding to detection signal strength for the detected signal of the OBSS, and the signal of the BSS is transmitted using the transmission signal strength. Note that determination as to whether or not to be a radio frame transmitted by the OBSS is performed using the BSS color. The OBSS PD based SR can perform the SR regardless of the type of a radio frame to be transmitted in the OBSS. On the other hand, the OBSS PD based SR is executed without considering the state of a receiver of the radio frame of the OBSS in which the SR is permitted. Therefore, in a case where the signal of the BSS is transmitted with the transmission signal strength determined as described above, there is a case where the signal of the BSS is strongly received at the position of the receiver of the OBSS depending on the position of the receiver, and the communication of the OBSS cannot be appropriately performed.

In view of such circumstances, the present embodiment provides a method for reducing the influence of the OBSS on communication while enabling the SR to be applied even in a case where radio frames other than the TB PPDU are transmitted in the OBSS using the OBSS PD based SR method. For example, in the OBSS, when a radio frame that permits application of the OBSS PD based SR, Ack for the radio frame, and the like are transmitted, information on the transmission signal strength of the signal to be transmitted is included. This enables the communication apparatus of the BSS to specify the magnitude of the influence on a transmitter and a receiver of the radio frame that permits the OBSS PD based SR in a case of executing communication using the OBSS PD based SR. More specifically, when a radio frame using the SR is transmitted, the radio frame reaches the receiver of the OBSS with reception signal strength reduced by the propagation loss from the transmission signal strength of the radio frame. A communication apparatus attempting to transmit a radio frame using the SR estimates the propagation loss from transmission signal strength of a radio signal transmitted from another communication apparatus of the OBSS and reception signal strength when the radio signal is received. Here, it is conceivable that propagation loss in a signal transmitted from another communication apparatus of the OBSS and arriving at the communication apparatus also occurs in propagation of a radio frame transmitted by the apparatus itself and arriving at another communication apparatus. Therefore, by specifying propagation loss between the communication apparatus and the other communication apparatus of the OBSS, the communication apparatus can estimate the degree of reception signal strength with which a radio frame reaches the other communication apparatuses on an assumption that the radio frame is transmitted using the SR. In this manner, the communication apparatus can estimate, by the propagation loss as described above, the magnitude of the influence on the reception processing by another communication apparatus of the OBSS when the radio frame is transmitted using the SR. Then, based on the magnitude of the propagation loss, the communication apparatus can determine transmission signal strength that does not affect communication of a radio frame in which the SR performed in the OBSS is permitted. This enables communication using the SR to be performed while sufficiently suppressing the influence of the OBSS that permits the SR on communication, and enables the wireless media to be effectively utilized.

### Apparatus Configuration

A configuration example of the communication apparatuses (AP 101 and AP 102 and STA 111 and STA 112) according to the present embodiment will be described with reference to FIG. 2. FIG. 2 illustrates a hardware configuration example of the communication apparatus. As illustrated in FIG. 2, the communication apparatus includes, for example, a storage unit 201, a control unit 202, a functional unit 203, an input unit 204, an output unit 205, a communication unit 206, and an antenna 207 as a hardware configuration thereof.

The storage unit 201 is configured to include one or more memories such as a ROM and a RAM, for example, and stores various types of information such as computer programs for performing various operations described later and communication parameters for wireless communication. Note that ROM is an abbreviation for read only memory, and RAM is an abbreviation for random access memory. In addition to or in place of the memory such as a ROM and a RAM, the storage unit 201 may include a storage medium such as a flexible disk, a hard disk, an optical disk, a magneto-optical disk, a CD-ROM, a CD-R, a magnetic tape, a nonvolatile memory card, and a DVD. The storage unit 201 may include a solid state drive (SSD). The storage unit 201 may include a plurality of memories.

The control unit 202 includes one or more processors such as a CPU and an MPU, for example, and controls the entire communication apparatus by executing computer programs stored in the storage unit 201, for example. CPU is an abbreviation for central processing unit, and MPU is an abbreviation for micro processing unit. The control unit 202 can be configured to execute processing of generating data and signals (wireless frame) to be transmitted in communication with other communication apparatuses, in addition to control of the entire communication apparatus. Note that the control unit 202 may be configured to execute processing such as control of the entire communication apparatus in cooperation with computer programs stored in the storage unit 201 and an operating system (OS), for example. The control unit 202 may include a plurality of processors that are multi-core and the like, and execute processing such as control of the entire communication apparatus by the plurality of processors. The control unit 202 may include an application specific integrated circuit (ASIC), a digital signal processor (DSP), or a field programmable gate array (FPGA).

The control unit 202 controls the functional unit 203 to execute predetermined processing such as imaging, printing, and projecting. The functional unit 203 is hardware for the communication apparatus to execute predetermined processing. For example, in a case where the communication apparatus is a camera such as a digital still camera or a smartphone having a camera, the functional unit 203 is an imaging unit and performs imaging processing of surrounding images. For example, in a case where the communication apparatus is a printer, the functional unit 203 is a printing unit, and performs printing processing on a sheet such as paper based on, for example, print data stored in the storage unit 201 or obtained from the outside via wireless communication or the like. For example, in a case where the communication apparatus is a projector or smart glasses, the functional unit 203 is a projection unit, and performs projection processing of, for example, image data or video data stored in the storage unit 201 or obtained from the outside via wireless communication or the like. In the case of smart glasses, the projection plane is the retina of an end user or the like. The data processed by the functional unit 203 may be data stored in the storage unit 201 or data communicated with another communication apparatus via the communication unit 206 described later. Furthermore, the communication apparatus can also provide a network storage function such as a network attached storage (NAS). This function is provided to another communication apparatus as a web service such as a network storage service. For example, the other communication apparatus is connected to a network storage service provided by the communication apparatus by using a protocol such as SMB, FTP, or WebDAV. The other communication apparatus can then upload a file to the storage service or download a file in the storage.

An input unit 204 accepts various operations from a user. An output section 205 provides various outputs to the user. Here, output by the output unit 205 includes at least one of, for example, display on a screen, sound output by a speaker, and vibration output. Note that as in a touch panel, both the input unit 204 and the output unit 205 may be implemented by one module. Each of the input unit 204 and the output unit 205 may be built in the communication apparatus, or may be configured as an external apparatus connected to the communication apparatus.

The communication unit 206 performs control of wireless communication compliant with the IEEE 802.11 series standards and control of internet protocol (IP) communication. In cooperation with, for example, the antenna 207, the communication unit 206 executes transmission and reception of an HE PPDU compliant with the IEEE 802.11ax standard. Note that the communication unit 206 can execute transmission and reception processing compliant with a standard in which at least the SR is adopted, in addition to or in place of the IEEE 802.11 standards. The antenna 207 is an antenna that can transmit and receive signals of at least any of frequency bands of, for example, the sub GHz band, the 2.4 GHz band, the 5 GHz band, the 6 GHz band, the 7 GHz band, and the 60 GHz band. Although one antenna 207 is illustrated in the present embodiment, the number of antennas may be two or more. In one example, different antennas may be prepared for respective frequency bands. In a case of including a plurality of antennas, the communication apparatus may include a plurality of the communication units 206 respectively corresponding to the plurality of antennas. Note that when the communication apparatus is compatible with the NFC standard, Bluetooth (registered trademark) standard, wired communication standards, or the like, the communication unit 206 configured to perform control of communication compliant with these communication standards can be prepared. Note that the communication unit 206 and the antenna 207 may be provided as integrated components, or may be prepared as separate components.

FIG. 3 illustrates a functional configuration example of the communication apparatus. The communication apparatus is configured to include, as a functional configuration thereof, a wireless LAN control unit 301, a frame processing unit 302, an SR management unit 303, a UI control unit 304, and a storage control unit 305. These functions can be implemented, for example, by the control unit 202 executing programs stored in the storage unit 201 or by a processing functional unit in the communication unit 206. Note that FIG. 3 is a view for describing main functions of the present embodiment, and other functions are omitted. Therefore, the communication apparatus can naturally have, for example, a function for control for establishment of connection or communication with a partner apparatus as a normal AP or STA, or functions generally included by the communication apparatus. A plurality of functional blocks in FIG. 3 may be integrated into one functional block, or one functional block may be divided into a plurality of functional blocks.

The wireless LAN control unit 301 is configured to include an antenna and a circuit for transmitting and receiving radio signals to and from another wireless LAN apparatus, and a programs for controlling them. Note that the communication apparatus may include a plurality of the wireless LAN control units 301. The wireless LAN control unit 301 executes communication control of the wireless LAN in accordance with the IEEE 802.11 series standards. The frame processing unit 302 performs processing such as generation and analysis of radio frames transmitted and received by the wireless LAN control unit 301. The content of generation and analysis of radio control frames in the frame processing unit 302 may be restricted by settings saved in the storage unit 305, or may be changed by user settings from the UI control unit 304. The frame generated by the frame processing unit 302 is transferred to the wireless LAN control unit 301 and transmitted via the wireless LAN control unit 301. The frame received by the wireless LAN control unit 301 is transferred to the frame processing unit 302 and analyzed by the frame processing unit 302. In a case where transmission of a radio frame is to be performed, the SR management unit 303 determines whether or not the SR can be used for the transmission of the radio frame based on parameters collected via the frame processing unit 302 so far. In a case of determining that the SR can be used for the transmission of the radio frame, the SR management unit 303 determines parameters such as the signal strength, the modulation multilevel number, and the packet length at the time of transmission of the radio frame, and notifies the wireless LAN control unit 301 and the frame processing unit 302 of the parameters. The frame processing unit 302 generates a transmission target radio frame using the notified parameters, and the wireless LAN control unit 301 transmits the generated radio frame with transmission power based on the notified parameters. The UI control unit 304 is configured to include hardware related to a user interface such as a touch panel or a button for receiving an operation input to the communication apparatus by a user not illustrated of the communication apparatus and programs for controlling those pieces of hardware. The UI control unit 304 can be configured to include hardware related to functions for presenting information to the user, such as display of an image or the like or sound output, and programs for controlling those pieces of hardware. The storage control unit 305 performs control for saving, in a storage apparatus such as a ROM or a RAM, programs and data by which the communication apparatus operates.

### Flow of Processing

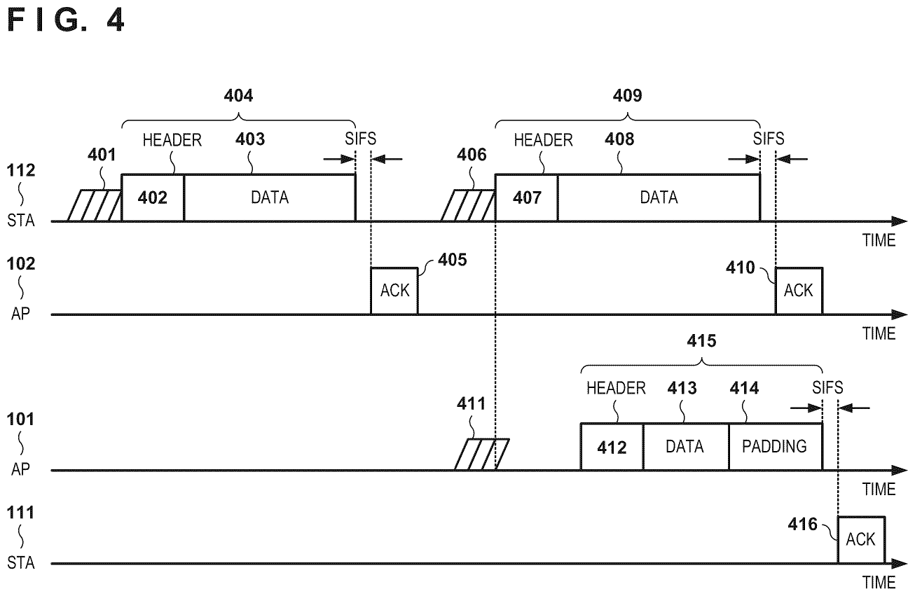

FIG. 4 illustrates an example of the flow of communication processing in the present embodiment. Here, the relative positional relationship among the AP 101, the AP 102, the STA 111, and the STA 112 is assumed to be in a state as illustrated in FIG. 1. Each of the communication apparatuses (AP 101, AP 102, STA 111, and STA 112) is assumed to perform wireless communication using a common frequency channel. It is assumed that the AP 101 and the AP 102 respectively form different BSSs, and these BSSs are in a relationship of the OBSS with each other. That is, it is assumed that the BSS formed by the AP 102 is an OBSS viewed from the AP 101 and the STA 111, and the BSS formed by the AP 101 is an OBSS viewed from the AP 102 and the STA 112.

The present processing example assumes that the radio frame transmitted from the STA 112 to the AP 102 is a radio frame that permits communication using the OBSS PD based SR by the OBSS. Therefore, in the radio frame transmitted from the STA 112 to the AP 102, information that permits the OBSS PD based SR is included in a PHY header and transmitted. Here, it is assumed that the AP 101 specifies that OBSS PD based SR is permitted from the PHY header of the radio frame transmitted by the STA 112 and attempts to use the SR in transmission of the radio frame addressed to the STA 112. At this time, the AP 101 according to the present embodiment can suppress the transmission signal strength of the radio frame so that the radio frame transmitted by the apparatus itself does not affect the reception result of the radio frame from the STA 112 in the AP 102.

For example, when transmitting a radio frame, the AP 101 suppresses the signal strength (transmission power) of the radio frame so that the radio frame is suppressed to about a noise floor due to thermal noise of the AP 102 at the time point when the radio frame reaches the AP 102. This can prevent the signal-to-noise ratio (SNR) of the radio frame received by the AP 102 from deteriorating. In other words, if a radio frame transmitted by the AP 101 arrives at the AP 102 with signal strength equal to or greater than thermal noise, there is a possibility that the SNR of the signal frame received by the AP 102 deteriorates to a non-negligible extent. In order to calculate what signal strength a radio frame transmitted by the AP 101 arrives at the AP 102 with, the AP 101 needs to specify propagation loss between the apparatus itself and the AP 102. Then, in order to specify this propagation loss, the AP 101 needs to be able to specify the transmission signal strength (transmission power) of the radio frame transmitted from the AP 102 and the reception signal strength (reception power) of the radio frame in the apparatus itself. That is, the difference between the transmission signal strength and the reception signal strength is the propagation loss between the AP 101 and the AP 102. The radio frame transmitted from the AP 101 is received by the AP 102 with the signal strength in which the magnitude of the propagation loss is subtracted from the transmission signal strength of the radio frame. Therefore, by specifying, as transmission signal strength, for example, a value in which the magnitude of the propagation loss is added to the noise floor level of the AP 102, the AP 101 can perform communication while suppressing the influence on reception of the radio frame in the AP 102.

On the other hand, a radio frame compliant with the known IEEE 802.11 standards other than some trigger frames used in the PSR-based SR does not include information on signal strength output from the communication apparatus on the transmission side of the radio frame. Therefore, it is not possible to specify propagation loss between, for example, the communication apparatus on the transmission side and a communication apparatus attempting to transmit a radio frame using the SR. Therefore, in the present embodiment, at the time of transmission of a radio frame that permits the SR and transmission of another radio frame related to the radio frame, information on the transmission signal strength of those radio frames is included in the radio frame and transmitted. That is, in the radio frame of a response (e.g., ACK) when transmitting a radio frame that permits the SR or receiving the radio frame, the AP 102 can transmit the transmission signal strength of the radio frame. This enables the AP 101 to obtain information on the transmission signal strength from the radio frame, and to specify propagation loss based on the information and a measurement result of the reception signal strength of the radio frame.

Note that when a radio frame that permits the SR is transmitted, information on the transmission signal strength of the radio frame can be included in a header of the radio frame. That is, in a radio frame including a header and data, information on transmission signal strength can be included not in a data part but in a header part. This is because a modulation method having a large modulation multilevel number is likely to be used in the data part, whereas a modulation method having a low modulation multilevel number (having the minimum modulation multilevel number, for example, among the available modulation methods) is likely to be used in the header part in order to reduce an error rate. That is, since the data part of a radio frame can be transmitted with the modulation multilevel number being adjusted to be high based on the reception quality of the radio frame in a communication apparatus on the receiving side thereof, there can be a case where the communication apparatus that transmits the radio frame by using the SR cannot demodulate the data part. On the other hand, the header part has a low modulation multilevel number so that the communication apparatus on the reception side can reliably demodulate the content thereof, and a communication apparatus that transmits the radio frame by using the SR can also perform demodulation. Therefore, by including information on transmission signal strength in the header part, the communication apparatus that transmits the radio frame by using the SR can obtain the information, and it is possible to increase the probability that propagation loss can be specified. Note that this is an example, and information on transmission signal strength may be included in the data part of the radio frame.

In not only a radio frame for data transmission that permits the SR but also a reception acknowledgement frame (ACK) for the radio frame, information on transmission signal strength can be included and transmitted. This enables the communication apparatus that transmits a radio frame using the SR to specify propagation loss between the communication apparatus and a communication apparatus on the reception side of the radio frame for data transmission that permits the SR.

Note that a communication apparatus likely to transmit or receive a radio frame for data transmission that permits the SR may send the surroundings information indicating transmission signal strength in a radio frame other than the radio frame for data transmission or the reception acknowledgement frame, for example. In one example, the communication apparatus can send the surroundings information indicating transmission signal strength by using a management frame such as a beacon frame. The communication apparatus may transmit a Request to Send (RTS) frame and a Clear to Send (CTS) frame in which information indicating the transmission signal strength to be used in subsequent communication is included. The communication apparatus can specify propagation loss between the communication apparatus and another communication apparatus of the OBSS by receiving those radio frames transmitted from the other communication apparatus of the OBSS and obtaining information on transmission signal strength. Then, when the other communication apparatus of the OBSS transmits and receives a radio frame that permits the SR, the communication apparatus can specify transmission signal strength in communication using the SR based on the propagation loss.

In FIG. 4, first, it is assumed that the AP 101 neither specifies nor stores propagation loss between the AP 101 and each of the AP 102 and the STA 112. Here, it is assumed that the STA 112 executes clear channel assessment (CCA), determines that a frequency channel to be used is free, and transmits the radio frame 404 including a header part 402 and a data part 403. Note that the CCA in the IEEE 802.11 standards is provided with a back-off period 401 that is a random standby time. Since this back-off period varies depending on each communication apparatus attempting to transmit a radio frame, it is possible to reduce the occurrence probability of collision due to a plurality of communication apparatuses simultaneously transmitting radio frames. The STA 112 transmits the header part 402 of the radio frame 404 in which information indicating that the OBSS PD based SR is permitted and the destination is the AP 102 and information on the transmission signal strength of this radio frame 404 are included. The AP 101 demodulates the header part 402, and recognizes that the OBSS PD based SR is permitted and that the destination thereof is the AP 102. The AP 101 specifies and stores, in the storage unit 201, propagation loss between the AP 101 and the STA 112 based on the information on transmission signal strength included in the header part 402 and reception strength of the radio frame 404. Based on a known SR, the AP 101 can start transmission of a radio frame using the SR in response to specifying that the OBSS PD based SR is permitted. On the other hand, in the present embodiment, the AP 101 does not execute the SR in a state where information on the destination of the radio frame that permits the OBSS PD based SR and propagation loss between the destination and the AP 101 are unknown. Therefore, the AP 101 does not transmit the radio frame using the SR within the transmission period of the radio frame 404

After the transmission of the radio frame 404 by the STA 112 is completed, the AP 102, which is the destination of the radio frame 404, transmits a reception acknowledgement frame (ACK 405) to the STA 112 after a short interframe space (SIFS) period. This ACK 405 includes information on transmission signal strength. The AP 102 demodulates the ACK 405, obtains information on the transmission signal strength, and based on the information and the reception strength of the ACK 405, specifies and stores, into the storage unit 201, propagation loss between the ACK 405 and the AP 102.

Note that an AP of a wireless LAN can be in a reception state constantly in a period other than transmission of a radio frame so that the AP can receive the radio frame addressed to the apparatus itself at any timing. Therefore, the AP 102 can constantly receive the radio frame transmitted by the AP 102 or the STA 112 operating in the same frequency channel. Therefore, the AP 101 can specify both the propagation loss between the AP 101 and the STA 112 and the propagation loss between the AP 101 and the AP 102. The AP 101 can maintain propagation loss at the latest value by constantly observing radio frames from other communication apparatuses and updating the value of the propagation loss.

After end of communication by the STA 112, the AP 101 starts CCA for transmitting a radio frame to the STA 111. At this time, it is assumed that the STA 112 also starts the CCA for transmitting a radio frame to the AP 102. Here, the STA 111 sets a back-off period 406, and the AP 101 sets a back-off period 411. Then, it is assumed that as a result of those CCA, the STA 111 starts transmission of a radio frame 409 including a header part 407 and a data part 408. Similarly to the radio frame 404, the radio frame 409 includes, in the header part 407, information indicating that the OBSS PD based SR is permitted and that the destination is the AP 102, and information on the transmission signal strength of this radio frame 409.

When detecting the radio frame 409 by the STA 111 while executing the CCA, the AP 101 determines that normal transmission cannot be performed, and attempts to transmit a radio frame using the SR. The AP 101 first demodulates the header part 407 of the radio frame 409 that contends in the CCA, and specifies the transmission source (STA 112) and the destination (AP 102) of the radio frame 409. The AP 101 can calculate the transmission signal strength of the radio frame that the AP 101 uses in the SR based on a value of propagation loss on the condition that the value of the propagation loss at least between the destination (AP 102) and the AP 101 is stored.

In the IEEE 802.11 standards, a communication apparatus needs to be able to receive an OFDM signal of 6 Mbps using BPSK having reception signal strength of −80 dBm or more. In other words, the communication apparatus may be unable to receive a signal having strength of less than −80 dBm. Therefore, in one example, the AP 101 adjusts the transmission signal strength of the radio frame to be transmitted so that the strength is less than −80 dBm in the STA 112 and the AP 102. By doing so, it is assumed that the AP 101 can transmit the radio frame without affecting communication between the STA 112 and the AP 102. However, a wireless LAN communication apparatus that can demodulate a signal of less than −80 dBm actually exists. Therefore, in another example, the AP 101 can adjust transmission signal strength of a radio frame and transmit the radio frame such that the reception signal strength is less than −100 dBm per 20 MHz in the STA 112 and the AP 102.

In the present embodiment, the AP 101 can calculate the transmission signal strength so that the reception signal strength in both the AP 102 and the STA 112 is less than −80 dBm. Then, the AP 101 starts transmission of a radio frame when communication with the STA 111 is possible with the calculated transmission signal strength. For example, it is assumed that propagation loss between the AP 101 and the AP 102 is 90 dB, and propagation loss between the AP 101 and the STA 112 is 70 dB. In this case, in order for the reception signal strength in the AP 102 to be less than −80 dBm, the transmission signal strength in the AP 101 is −80+90=less than 10 [dBm]. Similarly, in order for the reception signal strength in the STA 112 to be less than −80 dBm, the transmission signal strength in the AP 101 is −80+70=less than −10 [dBm]. The AP 101 can specify less than −10 dBm, which is the lower of those transmission signal strength, as the transmission signal strength available for transmission of radio frames. Note that the AP 101 may specify the transmission signal strength by calculation, or may store a table defining the relationship between the propagation loss and the transmission signal, for example, and specify the transmission signal strength by referring to the table. Then, when transmitting a radio frame with the transmission signal strength, the AP 101 determines whether the radio frame is received with sufficient reception signal strength in the STA 111, which is a communication partner apparatus, thereby determining whether communication with the STA 111 is possible. For example, the AP 101 can determine whether reception signal strength in the STA 111 is −80 dBm or more. The AP 101 can determine that communication with the STA 111 is possible when the reception signal strength in the STA 111 is −80 dBm or more. In one example, the AP 101 can set transmission signal strength as great as possible within a range of less than −10 dBm, the range where reception signal strength in the STA 111 of −80 dBm or more.

The AP 101 checks the length of the radio frame 409 and specifies (calculates) the timing at which the radio frame 409 ends. The AP 101 also specifies (calculates) a timing at which an ACK 410 transmitted to the STA 112 by the AP 102 ends. Then, the AP 101 determines the length of a radio frame 415 to be transmitted such that the timing at which the AP 102 completes transmission of the ACK 410 substantially coincides with the time at which the AP 101 completes transmission of radio frames. In one example, the AP 101 can adjust the length by inserting padding 414 using dummy data in the radio frame 415 including a header part 412 and a data part 413. This can be performed so that the timing of an ACK 416 by the STA 111 does not overlap the radio frame 409 or the ACK 410. Then, the AP 101 transmits the radio frame 415 having the adjusted length to the STA 111 with the transmission signal strength determined as described above. By determining the transmission signal strength of the radio frame 415 as described above, it is possible to prevent transmission of the radio frame 409 from strongly affecting both reception of the radio frame 415 by the AP 102 and reception of the ACK 410 by the STA 112.

Note that the padding 414 needs not be inserted. For example, by including, in the header part 412 or the data part 413, information indicating that the radio frame 415 is communication using the SR for communication between the AP 102 and the STA 112, the AP 101 may notify the STA 111 of the information. The STA 111 may determine the transmission signal strength of the ACK 416 similarly to the AP 101, for example, based on the propagation loss between the AP 102 and the STA 112 specified in advance similarly to the AP 101 described above and the information included in the radio frame 415. When such transmission of the ACK 416 is possible, insertion of the padding 414 may be omitted.

Note that in the above example, a case where the AP 101 sets transmission signal strength that affects neither the STA 112 nor the AP 102 has been described. However, transmission signal strength that does not affect only operation of reception of the AP 102 may be set. For example, in the above example, assuming that the transmission signal strength of the AP 101 is 10 dBm, the reception signal strength in the AP 102 is −80 dBm. Note that in this case, the AP 101 can adjust the length of the radio frame 415 to be transmitted so that transmission ends at the timing when transmission of the STA 112 ends. This is because there is a possibility that the STA 112, which is a communication apparatus on the reception side of the ACK 410, is strongly affected by the radio frame 415. Note that in this case, it is important that the ACK 416 that the STA 111 transmits to the AP 101 is transmitted with transmission signal strength to an extent of affecting reception of the ACK 410 by the STA 112. In a case where the radio frame 415 transmitted by the AP 101 is a radio frame in a format such as broadcast or multicast that does not require reception of the ACK 416, it is not necessary to consider signal strength of the ACK 416 transmitted by the STA 111. Due to this, since the AP 101 transmits the radio frame 415 with higher transmission signal strength, communication using the SR can be performed with higher efficiency.

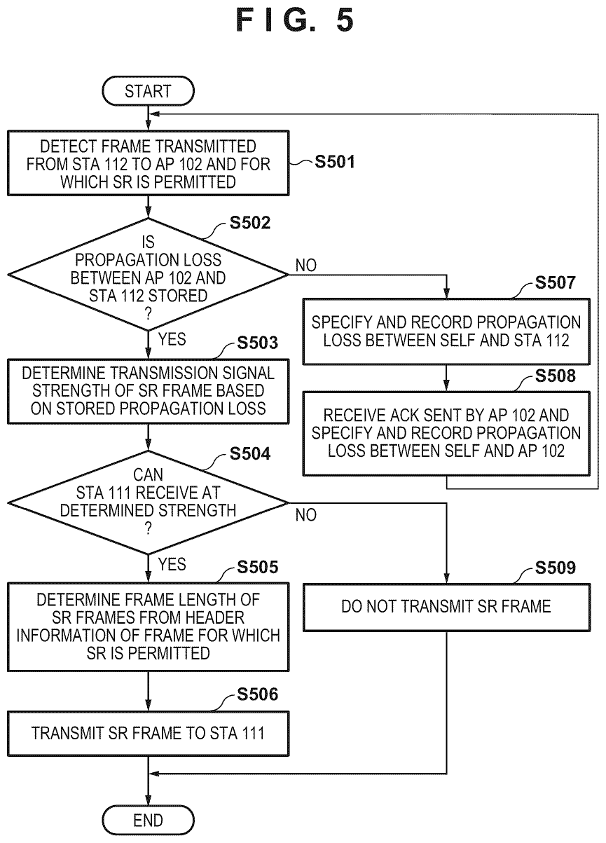

FIG. 5 shows an example of the flow of processing executed by a communication apparatus (AP 101 in the example of FIG. 4) that performs communication using the SR. This processing can be implemented, for example, by the control unit 202 executing a program stored in the storage unit 201 in the communication apparatus, or by the processing functional unit in the communication unit 206. Note that a case where the communication apparatus that performs the processing is the AP 101 will be described below, but this processing may be performed by another communication apparatus such as the STA 111. Note that it is assumed that the AP 101 has established a link so as to be able to perform wireless communication with the STA 111.

The AP 101 observes a radio frame of the OBSS transmitted and received in the surroundings, and demodulates a header part of the radio frame. By this demodulation, the AP 101 detects a radio frame in which, for example, the transmission source is the STA 112 and the destination is the AP 102 and the SR is permitted (S501). The AP 101 determines whether information on propagation loss between the AP 102 and the STA 112 is stored in the storage unit 201 (S502). If such information on propagation loss is not stored (NO in S502), the AP 101 specifies and records (S507) the propagation loss between the AP 101 and the STA 112 based on the radio frame detected in S501. That is, the AP 101 calculates and stores, in the storage unit 202, propagation loss between the own apparatus and the STA 112 from the information on the transmission signal strength included in the radio frame detected in S501 and the reception signal strength at the time of receiving the radio frame. The AP 101 receives an ACK from the AP 102 for the radio frame transmitted from the STA 112, and similarly calculates and stores, in the storage unit 202, propagation loss between the AP 101 and the AP 102 (S508). Then, the process returns to S501.

When determining that the information on the propagation loss between the AP 102 and the STA 112 is stored in the storage unit 201 (YES in S502), the AP 101 determines the transmission signal strength of the radio frame to be transmitted using the SR based on the information on the propagation loss (S503). That is, the AP 101 can calculate the transmission signal strength of the radio frame to be transmitted so that at least the reception signal strength in the AP 102 becomes equal to or less than a predetermined level. The AP 101 may calculate the transmission signal strength of the radio frame to be transmitted so that the reception signal strength in both the AP 102 and the STA 112 becomes equal to or less than a predetermined level. Then, when transmitting a radio frame with the determined transmission signal strength, the AP 101 determines whether the STA 111 can receive the radio frame (S504). For example, in a case where the reception signal strength in the STA 111 of the transmitted radio frame becomes a predetermined level or greater, the AP 101 determines that the STA 111 can receive the radio frame. When determining that the STA 111 cannot receive the radio frame (NO in S504), the AP 101 determines not to transmit a radio frame using the SR (S509). By transmitting the radio frame although the STA 111 cannot receive the radio frame transmitted by the AP 101, it is possible to suppress an increase in unnecessary interference with the surroundings. On the other hand, when determining that the STA 111 can receive a radio frame with the determined transmission signal strength (YES in S504), the AP 101 determines the length of the radio frame using the SR (S505). The AP 101 obtains information on the frame length from a header part of the radio frame detected in S501, for example, and determines the length of the radio frame to be transmitted in accordance with the frame length. Then, the AP 101 transmits a radio frame having the determined frame length to the STA 111 with the determined transmission signal strength (S506).

As described above, the communication apparatus obtains information on transmission signal strength of a radio frame included in the radio frame transmitted from the first other communication apparatus on the reception side of the OBSS, and specifies propagation loss between the communication apparatus and the first other communication apparatus. Then, when the second other communication apparatus on the transmission side of the OBSS transmits a radio frame that permits communication using the SR, the communication apparatus can determine, based on the propagation loss, transmission signal strength at a level that does not affect the first other communication apparatus. When the second other communication apparatus transmits a radio frame that permits communication using the SR, the communication apparatus can transmit the radio frame with the determined transmission signal strength using the SR while sufficiently suppressing the influence on the first other communication apparatus. The communication apparatus may specify propagation loss similarly for the second other communication apparatus, and determine transmission signal strength at a level that does not affect the second other communication apparatus. In this case, for example, also when a radio frame such as ACK is transmitted from the first other communication apparatus to the second other communication apparatus, the communication apparatus can transmit the radio frame with the determined transmission signal strength using the SR while sufficiently suppressing the influence on the second other communication apparatus.

Note that in the above-described embodiment, an example has been described in which the STA 112 of the OBSS transmits a radio frame that permits the SR in which information on transmission signal strength is included, and similarly, the AP 102 transmits the radio frame in which information on transmission signal strength is included in the ACK to the radio frame. However, the present invention is not limited to this. That is, when transmitting a radio frame, each of the communication apparatuses may constantly transmit the radio frame in which information on transmission signal strength is included. When detecting the radio frame, the AP 101 of the BSS obtains information on transmission signal strength and specifies and stores propagation loss (alternatively, updates the stored information) from information on reception signal strength of the radio frame and the transmission signal strength. On the other hand, when use of the SR is not permitted in a radio frame transmitted from the STA 112, the AP 101 does not transmit the radio frame during transmission of the radio frame. When use of the SR is permitted in the radio frame transmitted from the STA 112, the AP 101 can determine the transmission signal strength from the stored propagation loss during transmission of the radio frame, and transmit the radio frame with the transmission signal strength by using the SR. In this manner, propagation loss may be continuously updated while the SR is not permitted, and when the SR is permitted, the radio frame may be immediately transmittable using the SR. Note that in this case, the communication apparatus needs not specify the destination of the radio frame when specifying propagation loss based on the radio frame received from the other communication apparatus. That is, since the communication apparatus can specify propagation loss from the transmission signal strength at the time of transmitting a radio frame from the other communication apparatus and the reception signal strength at the time of receiving the radio frame, it is not necessary to specify the destination of the radio frame. On the other hand, when performing communication using the SR, the communication apparatus can check the destination of a radio frame in which the SR is permitted, and based on the propagation loss for the communication apparatus of the destination, determine the transmission signal strength with which an influence on the communication apparatus of the destination is sufficiently suppressed.

In the above example, an example has been described in which in the OBSS, the STA 112 transmits a radio frame to the AP 102 and the AP 101 attempts to transmit a radio frame to the STA 111. However, this is merely an example. That is, in the OBSS, the AP 102 may transmit a radio frame to the STA 112, or the STA 111 may attempt to transmit a radio frame to the AP 101. The AP 102 and the STA 112 may execute the processing executed by the AP 101 described above with the AP 101 and the STA 111 as the OBSS.

According to the present invention, use efficiency of a radio medium can be improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001498, filed Jan. 9, 2024 which is hereby incorporated by reference herein in its entirety.

What is claimed is:

1. A communication apparatus that performs wireless communication compliant with IEEE 802.11 standard, comprising:
at least one memory storing instructions; and
at least one processor that executes the instructions stored in the at least one memory to cause the communication apparatus to perform:
obtaining information on first transmission signal strength of a first radio frame, the information being included in the first radio frame transmitted from a first other communication apparatus of an overlapping basic service set (OBSS), and obtaining reception signal strength when the first radio frame is detected;
specifying propagation loss between the first other communication apparatus and the communication apparatus from the first transmission signal strength and the reception signal strength;
determining a second transmission signal strength to be used in transmission of a third radio frame using spatial reuse (SR) based on the propagation loss specified when a second radio frame transmitted from a second other communication apparatus of the OBSS with the first other communication apparatus as a destination permits SR; and
transmitting the third radio frame using SR while the second radio frame is being transmitted using the second transmission signal strength.

2. The communication apparatus according to claim 1, wherein the at least one processor further executes the instructions to cause the communication apparatus to perform determining whether or not a third other communication apparatus that is a destination of the third radio frame can receive the third radio frame when the communication apparatus transmits the third radio frame with the second transmission signal strength, and
wherein when determining that the third other communication apparatus cannot receive the third radio frame, the communication apparatus does not transmit the third radio frame.

3. The communication apparatus according to claim 1, wherein the at least one processor further executes the instructions to cause the communication apparatus to perform adjusting a length of the third radio frame such that transmission of the third radio frame ends at a timing when transmission of the second radio frame ends.

4. The communication apparatus according to claim 1, wherein the information on the first transmission signal strength is included in a header part of the first radio frame.

5. The communication apparatus according to claim 1, wherein the at least one processor further executes the instructions to cause the communication apparatus to perform:
obtaining information on a third transmission signal strength of a fourth radio frame included in the fourth radio frame transmitted from the second other communication apparatus, and obtaining a second reception signal strength when the fourth radio frame is detected,
specifying propagation loss between the second other communication apparatus and the communication apparatus from the third transmission signal strength and the second reception signal strength, and
determining the second transmission signal strength based on both the propagation loss between the first other communication apparatus and the communication apparatus and the propagation loss between the second other communication apparatus and the communication apparatus.

6. The communication apparatus according to claim 5, wherein the at least one processor further executes the instructions to cause the communication apparatus to perform adjusting a length of the third radio frame such that transmission of the third radio frame ends at a timing when the first other communication apparatus ends transmission of a reception acknowledgement frame to the second radio frame.

7. A communication apparatus that performs wireless communication compliant with IEEE 802.11 standard, comprising:
at least one memory storing instructions; and
at least one processor that executes the instructions stored in the at least one memory to cause the communication apparatus to perform:
transmitting a radio frame in which information on transmission signal strength of the radio frame is included in the radio frame when use of spatial reuse (SR) is permitted in the radio frame to be transmitted, or a reception acknowledgement frame in which information on transmission signal strength of the reception acknowledgement frame is included in the reception acknowledgement frame when a radio frame in which use of SR is permitted is received.

8. The communication apparatus according to claim 7, wherein the information on the transmission signal strength is included in a header part of the radio frame and transmitted.

9. The communication apparatus according to claim 8, wherein information indicating that use of the SR is permitted is further included in the header part and transmitted.

10. A communication method executed by a communication apparatus that performs wireless communication compliant with IEEE 802.11 standard, the communication method comprising:
obtaining information on first transmission signal strength of a first radio frame included in the first radio frame transmitted from a first other communication apparatus of an overlapping basic service set (OBSS), and obtaining reception signal strength when the first radio frame is detected;
specifying propagation loss between the first other communication apparatus and the communication apparatus from the first transmission signal strength and the reception signal strength;
determining a second transmission signal strength to be used in transmission of a third radio frame using spatial reuse (SR) based on the propagation loss specified when a second radio frame transmitted from a second other communication apparatus of the OBSS with the first other communication apparatus as a destination permits SR; and
transmitting the third radio frame using SR while the second radio frame is being transmitted using the second transmission signal strength.

11. A communication method executed by a communication apparatus that performs wireless communication compliant with IEEE 802.11 standard, the communication method comprising:
transmitting a radio frame in which information on transmission signal strength of the radio frame is included in the radio frame when use of spatial reuse (SR) is permitted in the radio frame to be transmitted, or a reception acknowledgement frame in which information on transmission signal strength of the reception acknowledgement frame is included in the reception acknowledgement frame when a radio frame in which use of SR is permitted is received.

12. A non-transitory computer-readable storage medium storing a program to cause, when the program is executed by at least one processor, a communication apparatus that performs wireless communication compliant with an IEEE 802.11 standard to perform:
obtaining information on first transmission signal strength of a first radio frame, the information being included in the first radio frame transmitted from a first other communication apparatus of an overlapping basic service set (OBSS), and obtaining reception signal strength when the first radio frame is detected;
specifying propagation loss between the first other communication apparatus and the communication apparatus from the first transmission signal strength and the reception signal strength;
determining a second transmission signal strength to be used in transmission of a third radio frame using spatial reuse (SR) based on the propagation loss specified when a second radio frame transmitted from a second other communication apparatus of the OBSS with the first other communication apparatus as a destination permits SR; and
transmitting the third radio frame using SR while the second radio frame is being transmitted using the second transmission signal strength.

13. A non-transitory computer-readable storage medium storing a program to cause, when the program is executed by at least one processor, a communication apparatus that performs wireless communication compliant with an IEEE 802.11 standard to perform:
transmitting a radio frame in which information on transmission signal strength of the radio frame is included in the radio frame when use of spatial reuse (SR) is permitted in the radio frame to be transmitted, or a reception acknowledgement frame in which information on transmission signal strength of the reception acknowledgement frame is included in the reception acknowledgement frame when a radio frame in which use of SR is permitted is received.
